(19) United States
(12) Patent Application Publication
(10) Pub. No.: US 2007/0223785 A1
(43) Pub. Date: Sep. 27, 2007

(54) Image processor and method

(75) Inventor: Yasuhito Sano, Yokohama-shi (JP)

Correspondence Address: YOUNG & BASILE, P.C., 3001 WEST BIG BEAVER ROAD, SUITE 624, TROY, MI, 48084, US

(73) Assignee: Nissan Motor Co., Ltd., Yokohama-shi (JP)

(21) Appl. No.: 11/726,213

(22) Filed: Mar. 21, 2007

(30) Foreign Application Priority Data
Mar. 22, 2006 (JP) 2006-078800

(51) Int. Cl. G06K 9/00; G06K 9/46

(52) U.S. Cl. 382/103; 382/195

(57) ABSTRACT

An apparatus for image processing. An image processor includes an image input device for capturing a pickup image and a controller. The controller is operable to select a target image corresponding to the pickup image by comparing the pickup image with a plurality of prepared target images. A type of the pickup image is identified based on the target image selected.

### CROSS-REFERENCE TO RELATED APPLICATION

This application claims priority from Japanese Patent Application Serial No. 2006-078800, filed Mar. 22, 2006, which is incorporated herein in its entirety by reference.

### TECHNICAL FIELD

The present invention pertains to an image processor and an image processing method by which pickup image processing time can be reduced.

### BACKGROUND

One example of a conventional image processor is described in Japanese Patent Application No. 2005-100121. This image processor, in order to identify the types of targets in a pickup image, prepares multiple sample data known to be of specific targets and prepares multiple sample data that are not of the specific targets. Next, for the entire area of the pickup image from the multiple sample data, the image processor creates multiple identification references for identifying portions of the pickup image corresponding to the specific targets, and those corresponding to the other targets are created. Then the image processor specifies index values that indicate amounts of computation necessary for deriving feature values that correspond to the multiple identification references from the pickup image. Finally, the image processor identifies the types of targets in the pickup image based on index values indicating identification precision and index values indicating the computation amounts.

### BRIEF SUMMARY OF THE INVENTION

Embodiments of an image processor are taught herein. According to one exemplary embodiment, the image processor comprises an image input device for capturing a pickup image and a controller. The controller is operable to select a target image corresponding to the pickup image by comparing the pickup image with a plurality of prepared target images and identify a type of the pickup image based on the selected target image.

According to another exemplary embodiment, the image processor comprises an image input device for capturing a pickup image and a controller. The controller is operable to compute a first feature value of the pickup image, extract second feature values of a plurality of respective prepared target images, compare the first feature value with the second feature values, select a second feature value corresponding to the first feature value and identify a type of the pickup image based on the selected second feature value.

According to yet another exemplary embodiment, an image processor can comprise an image capturing device operable to capture an image of a person in a target area and a controller. The controller is operable to analyze the image of the person, select a prepared image corresponding to the image of the person and identify a type of movement of the person in the target area based on the selected prepared image.

The image processor can also comprise, by example, means for capturing a pickup image, means for selecting a target image corresponding to the input image by comparing the pickup image with a plurality of prepared target images and means for identifying a type of the pickup image based on the target image selected by the means for selecting.

Methods of processing an image are also taught herein. One example of a method taught herein comprises computing a first feature value of a pickup image, determining a target area where the first feature value is present within the pickup image, extracting second feature values from prepared target image data, generating identification formulas related to the second feature values, selecting an identification formula associated with a second feature value corresponding to the first feature value and identifying a type of target in the target area based on the selected identification formula.

### BRIEF DESCRIPTION OF THE DRAWINGS

The description herein makes reference to the accompanying drawings wherein like reference numerals refer to like parts throughout the several views, and wherein:

FIG. 1 is a block diagram of an image processor pertaining to an embodiment of the invention;

FIG. 2 is a flow chart of operations of an embodiment of the invention;

FIG. 3 is an example extraction of a candidate area based on an optical flow;

FIG. 4 comprises examples of how learning data may be divided; and

FIG. 5 is a flow chart showing operations of an embodiment of the invention when a learning method based on the learning algorithm Adaboost is used.

### DETAILED DESCRIPTION OF EMBODIMENTS OF THE INVENTION

In conventional image processor technology, such as that described above, identification references for identifying image data are generated, and index values indicating identification precision are specified for all areas of a pickup image using multiple pickup image sample data known to be of specific targets and multiple sample data that are not of the specific targets. Accordingly, a large amount of processing (or computation) time was required to identify the targets in the pickup image. This results in a problem whereby it is difficult to identify quickly the types of targets in the pickup image.

In contrast, as taught herein, in an embodiment of this invention a first feature value of a pickup image is computed first, and a target candidate area where the first feature value is present is then extracted from the entire pickup image. Next, second feature values of prepared images are computed, and multiple identification formulas for the second feature values are generated. Next, the identification formula that corresponds to the feature value that is corresponding to the first feature value is selected. The type of target in the target candidate area is identified based on the selected identification formula.

As a result, there is no need to apply identification processing to all areas in the pickup image. The identification can be achieved using the rather restricted target, that is, the feature value within the target candidate area, so that the type of target can be identified quickly.

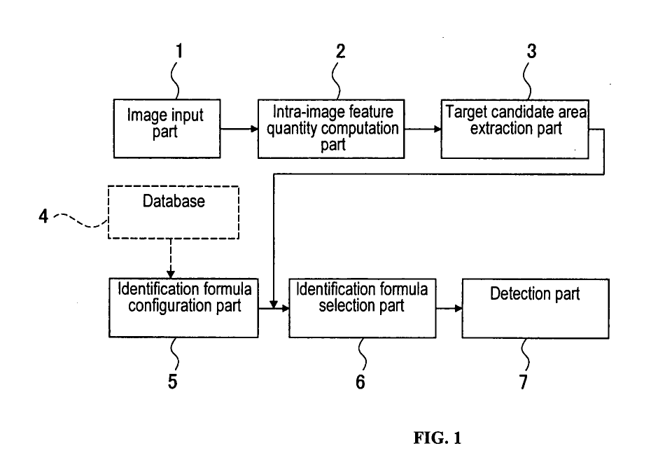

More specifically, FIG. 1 shows a configuration of one embodiment of an apparatus for image processing, or image processor, taught herein. The image processor includes an image input device 1 for inputting a pickup image and a controller. The controller can be, for example, a microcomputer including a central processing unit (CPU), input and output ports (I/O), random access memory (RAM), keep alive memory (KAM), a common data bus and read only memory (ROM) as an electronic storage medium for executable programs and certain stored values as discussed hereinafter. The functions performed by the parts of the image processor described herein could be, for example, implemented in software as the executable programs of the controller, or could be implemented in whole or in part by separate hardware in the form of one or more integrated circuits (IC).

The image processor is equipped with an intra-image feature value computation part 2 that computes a feature value of the pickup image input by image input device 1 and a target candidate area extraction part 3 that extracts a target candidate area from the pickup image using the feature value. The image processor also includes a database 4 in which image data for various target images are stored in advance. An identification formula generation part 5 computes feature values of the targets based on the image data stored in database 4 so as to generate multiple identification formulas that correspond to the feature values. An identification formula selection part 6 selects an identification formula from the multiple identification formulas generated by identification formula generation part 5 based on the feature value within the target candidate area extracted by target candidate area extraction part 3. Finally, a detection part 7 of the image processor detects whether a target is present in the target candidate area based on the identification formula selected by identification formula selection part 6. Furthermore, the image data may be prepared other than in database 4. In such a case, database 4 is no longer needed.

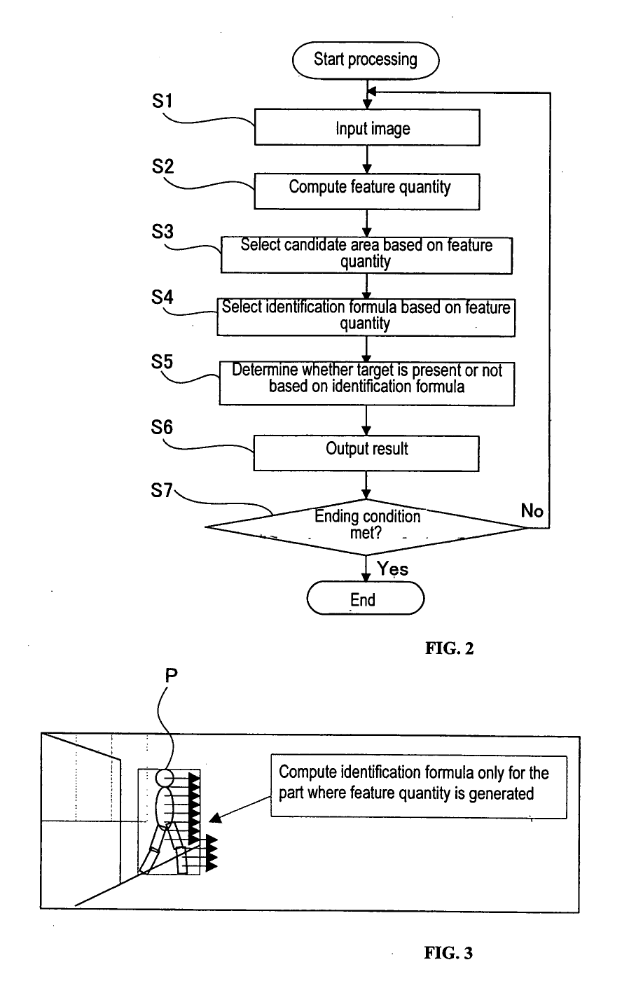

FIG. 2 shows the flow of operations carried out by an image processor according to FIG. 1. First, in step S1 image input device 1 inputs a pickup image. A digital image input device that contains a CCD sensor, a CMOS sensor or an amorphous sensor, or a device that takes an analog signal as an input and converts it into a digital image, may be utilized as image input device 1. In addition, the image input here is not restricted to the visible light area; an input image from outside the visible light area, such as an infrared image, may be utilized also.

In step S2 the feature value of the pickup image input in step S1 is computed. By example, optical flow, spatial frequency, edge strength, contrast and aspect ratio are available here as the feature value. When optical flow is to be used as the feature value, for example, a gradient method in which changes in the image are observed based on the difference between image Inputₜ obtained at time t and image Input_{t+Δt} obtained at time t+Δt is typically utilized. Spatial frequency is an index that indicates texture changes within an image, and it refers to the number of waves per unit distance. Edge strength is an index that indicates the strength of information regarding the boundary between textures within an image. Contrast indicates brightness differences from among areas within an image. Aspect ratio indicates the horizontal-to-vertical ratio of a rectangular area within an image.

In step S3 an area where the target is thought to be projected is extracted as candidate area p from the feature value obtained in step 2. For example, when a pedestrian projected on the screen is to be used as the target, as shown in FIG. 3, it is feasible to extract an area in which an object moves differently from the optical flow that originates from the source, or vanishing point, of the optical flow.

More specifically, the vanishing point from which the optical flow originates is obtained by obtaining the intersection of the optical flows on the screen, and an optical flow in a direction different from the direction originating from the vanishing point is picked up subsequently in order to extract candidate area p. At this time, a rectangle with the same aspect ratio as that of the learning data to be used later is used as candidate area p, and its size and location are decided in such a manner that an optical flow different from the background fits therein at a prescribed ratio or greater with respect to an optical flow in the same direction as the background.

In FIG. 2, appropriate target identification formula φₖ for candidate area p obtained in step S3 is selected in step S4 based on the feature value observed within the candidate area. Here, an identification formula φₖ is to be used to determine whether the target is projected in the input candidate area p, and it is expressed by the formula:

$${ϕ}_{k} = {\sum }_{i}^{N} {C}_{i} ( p ) ; wherein \qquad ( 1 )$$

identification formula φₖ is composed of a combination of N units of simple learning apparatuses called weak learning apparatus Cᵢ. Weak learning apparatus Cᵢ is a formula that returns 1 when the target is projected inside of the candidate area or 0 when the candidate is not projected therein. In the case of an identification method that utilizes identification formula φₖ, a threshold value μₖ is prepared. Thereby, a decision is made that the target is present when the output of formula φₖ is greater than threshold value μₖ, or that the target is absent when the output of formula φₖ is lower.

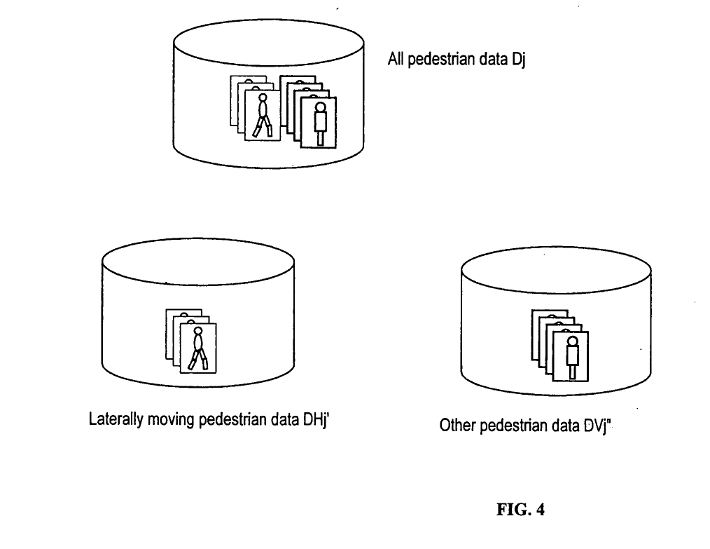

Then, the data used for the learning (that is, the learning data) are classified into anticipated feature values, and an identification formula is generated for each learning data classified. For example, when pedestrians are captured as targets (as in FIG. 3), it is expected that a lateral optical flow is observed of a pedestrian who is moving sideways, and the same optical flow as that of the background is observed of a pedestrian who is moving in a back or forth direction with respect to the camera. Therefore, as shown in FIG. 4, learning data Dⱼ are classified into learning data DH_{j′} where max (j′)=Mₕ<M for the pedestrian who is projected sideways and into learning data DV_{j″} where max (j″)=(M−Mₕ)<M. An identification formula is generated for each of them.

The diversity of the learning data can be restricted by classifying the learning data according to given conditions in this manner. When it is necessary to achieve a certain identification performance, the more diverse the learning data are, the larger the number of weak learning apparatuses that are required. This point will be explained later. As a result, identification formulas can be generated that require fewer weak learning apparatuses than do identification formulas obtained from a chunk of learning data.

Next, the principle that the computation time is reduced when the identification formulas are prepared individually based on the feature values is explained.

The most primitive method for obtaining a classification method through learning of data is a method that involves rote memorization of all learning data. A new datum is checked against all the data, and the class to which the closest learning data belong is returned for the purpose of classification (this is known as a k-NN method). Although this technique is known to result in a fairly high level of performance, it often cannot be utilized in reality because a large database is required when classification is to be carried out.

To the contrary, in most learning techniques, features suitable for classification are extracted from learning data, and decisions are made during the classification using the quantities of these features. In the case of the learning algorithm Adaboost (short for adaptive boosting as known to those skilled in the art), too, feature values for dividing images containing targets and images not containing targets efficiently from learning data are extracted during the weak learning formula generation process.

Conventional learning techniques conduct learning necessary for classifying data points, which are distributed over a feature value space with axes that correspond to two feature values, first feature value x₁ and second feature value x₂, into data points that indicate data on specific contents and into data points that do not indicate data on specific contents. As for boosting, processing is applied to the entire pickup image repeatedly for the purpose of learning during which a first set of data points is selected out of a sample data point group comprising multiple data points known to indicate the data regarding specific contents and multiple data points known to be otherwise. For instance, a first straight line or relatively simple curve on a feature value plane that best classifies those data points in the first set is identified and then a second set of data points that cannot be classified well using the first straight line or the curve is then selected, and a second straight line or a curve that best classifies those data in the second set is identified. Finally the multiple straight lines or curves identified through the processing series are integrated in order to decide the optimum line to be used to divide the feature value plane by means of the majority voting technique.

Using Adaboost, processing is applied to the entire pickup image repeated for the purpose of learning, during which respective data points that constitute a sample data point group similar to the one described above are weighted, a first straight line or a curve on a feature value plane that best classifies all the data points is identified, weighting of those data points that could not be classified correctly using the first straight line or the curve is increased, and the weights of the respective data points are then added so as to identify a second straight line or a curve that can well classify the data points.

In an embodiment of this invention, a target candidate area where a first feature value of a pickup image is present is first extracted and it is then decided whether a target is present in the target candidate area based on an identification formula that corresponds to the second feature value corresponding to the first feature value of the image data prepared. Because the search range can be narrowed down to a part of the image pickup, there is no need to manipulate the entire image pickup. Therefore the processing time after the capturing of an image to the identification of an image as a specific target can be reduced, allowing identification of a specific target much quicker after an image is captured.

Although formulas for identifying classes become simple when differences from among the classes in the learning data are clear (for example, when simple indices, such as bright and dark, can be used for identification), the formulas used for identification end up becoming long (in the case of Adaboost, number N of weak learning formulas C₁ ends up becoming large) when a great diversity of information is involved within the same class and cannot be described using simple rules. Therefore, when the learning data are divided based on some type of references so as to carry out the learning individually, the identification formulas become shorter, and the computation time is reduced as a result.

Referring now to step S4 of FIG. 2, an identification formula suitable for the candidate area is selected based on the feature value observed within the candidate area. In the example shown above, identification formula φₕ for learning data DH_{j′} on a pedestrian facing sideways is applied when a lateral velocity is observed often in the candidate area, and identification formula φᵥ for data DV_{j″} on the other pedestrians is applied to pedestrians for whom velocities in the other directions are observed. In addition, when it is not clear which identification formula should be applied, both identification formulas φₕ and φᵥ are applied.

In step S5 a decision is made using the identification formula in order to determine whether the target is projected inside of the target candidate area. The image in the candidate area is inputted into the identification formula, and the output value is compared with the threshold value. Thereby, a decision is made that the target is included in the candidate area when the output value is greater than the threshold value.

Then, the result of this determination is output in step S6, and the respective steps S1 through S6 are repeated until an ending condition is met in step S7.

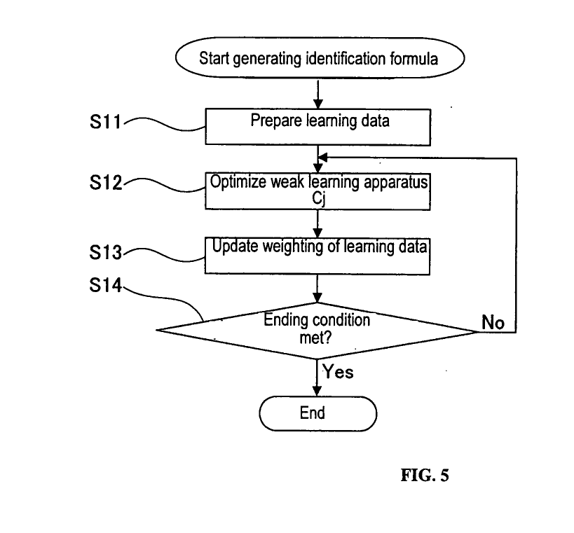

FIG. 5 shows a flow chart that describes learning by the weak learning apparatus. First, in step S11 of FIG. 5, M sets of learning data Dⱼ are prepared. Here, the learning data comprises image data Iⱼ, data Xⱼ that indicate whether the target is projected in the image and weights Wⱼ set for the respective sets of data. Furthermore, when edge strength is to be computed, a Sobel filter may be utilized with respect to the pickup image input by image input device 1 (refer to FIG. 1).

In step S12 weak learning apparatus C₁₌₁ is prepared, and Cᵢ₌₁ is optimized in such a manner that all identification errors with respect to the learning data are eliminated. Here, weak learning apparatus Cᵢ₌₁ is a formula that takes an optical flow within the image represented by the learning data as an input so as to determine whether the target is present in the image. In the embodiment shown, a decision is made that the target is present when the difference between the newly input optical flow and the optical flow already learned is equal to or less than a prescribed value. In this case, positions of the pixels to be compared are used as variables, and the positions of the pixels that refer to the optical flow in the image are optimized using an optimization technique such as local searches and hereditary algorithms so as to minimize the error rate.

In step S13 weighting of the learning data is updated. The weight applied to learning data that could not be classified accurately using the optimized weak learning apparatus is increased, and the weight applied to learning data that were optimized successfully is reduced for the purpose of learning of learning data that could not be classified accurately using Cᵢ₌₁, with more emphasis in the next learning phase.

In step S14 the performance of the identification formula obtained in step S12 is evaluated in order to determine whether a target value has been reached. If the target value has not yet been reached, operations for optimizing a new weak learning apparatus in step S12, further updating the weighting in step S13 and evaluations of the performance using Cᵢ₌₁ and Cᵢ₌₂ in step S14 are repeated. Processing ends if the obtained identification formula has already reached the target performance.

In one embodiment of the invention the image processor determines whether a target is projected inside of the candidate area using identification formulas when optical flow is used as the feature value. Optical flow is the product of the computations of movements of feature points within images captured at a cycle of Δt. For example, when an object is present at the coordinates of (x₁, y₁) at t₁ and it has moved to coordinates (x₂, y₂) at t₂, the optical flow across the images can be expressed as ((x₂−x₁)/Δt, y₂−y₁/Δt). In this embodiment the identification formulas are defined as follows, for example.

The identification formula for a pedestrian who is moving to the right is:

φ_{kR}=C_{1R}(p)+C_{2R}(p)+ . . . +C_{N-1R}(p)+C_{NR}(p); wherein

### C_{1R} (p) is the weak learning apparatus for a rightward vector (optical flow) at speed v1;

### C_{2R} (p) is the weak learning apparatus for a rightward vector (optical flow) at speed v2;

### C_{N-1R} (p) is the weak learning apparatus for a rightward vector (optical flow) at speed vN−1; and

### C_{NR}(p) is the weak learning apparatus for a rightward vector (optical flow) at speed vN.

The identification formula for a pedestrian who is moving closer is:

φ_{kC}=C_{1C}(p)+C_{2C}(p)+ . . . +C_{N-1C}(p)+C_{NC}(p); wherein

### C_{1C} (p) is the weak learning apparatus for a frontward vector (optical flow) at speed v1;

### C_{2C} (p) is the weak learning apparatus for a frontward vector (optical flow) at speed v2;

### C_{N-1C} (p) is the weak learning apparatus for a frontward vector (optical flow) at speed vN−1; and

### C_{NC} (p) is the weak learning apparatus for a frontward vector (optical flow) at speed vN.

Finally, the identification formula for a pedestrian who is moving to the left is:

φ_{kL}=C_{1L}(p)+C_{2L}(p)+ . . . +C_{N-1L}(p)+C_{NL}(p); wherein

### C_{1L} (p) is the weak learning apparatus for a leftward vector (optical flow) at speed v1;

### C_{2L} (p) is the weak learning apparatus for a leftward vector (optical flow) at speed v2;

### C_{N-1L} (p) is the weak learning apparatus for a leftward vector (optical flow) at speed vN−1; and

### C_{NL} (p) is the weak learning apparatus for a leftward vector (optical flow) at speed vN.

Then, assuming that the optical flow in candidate area p is rightward at speed of v2, by example, identification formula φ_{kR} is selected for candidate area p, wherein the identification formula φ_{kR} is expressed as:

φ_{kR}=C_{1R}(p)+C_{2R}(p)+ . . . +C_{N-1R}(p)+C_{NR}(p)=0+1+ . . . +0+0≧μₖ; and

a decision is made that a pedestrian who is moving rightwardly at speed v2 inside of candidate area p is present.

In actuality, the respective weak learning apparatuses are set for multiple vectors. For example, in the case of a pedestrian who is moving to the right, an optical flow (vectors) corresponding to the head, the torso, the arm/hand, the leg, and so forth is computed based on a prescribed resolution, and the collection of these vectors are learned as a single pattern. According to an embodiment of this invention there is no need to manipulate the entire screen because a search range can be narrowed down to a part of the screen so that the computation time can be reduced.

In another embodiment of the invention the image processor determines whether a target is projected inside of the candidate area using identification formulas when edge strength is used as the feature value. Edge strength is an index representing the strength of information on the boundary between the textures in the image, and it is handled a change in the brightness in a given direction within the image. For example, when the brightness is b₁ at (x₁, y₁), and the brightness is b₂ at (x₂, y₂), the edge strength is expressed by the value obtained by dividing the brightness difference between (x₁, y₁) and (x₂, y₂) by the distance between them, that is (b₂−b₁)/x₂−x₁). In this embodiment the identification formulas are defined as follows, for example.

The identification formula for a pedestrian is:

φ_{kEW}=C_{1EW}(p)+C_{2EW}(p)+ . . . +C_{N-1EW}(p)+C_{NEW}(p); wherein

### C_{1EW} (p) is the weak learning apparatus for a pedestrian image with the edge strength EW1 (when sunny);

### C_{2EW} (p) is the weak learning apparatus for a pedestrian image with the edge strength EW2 (when raining);

### C_{N-1EW} (p) is the weak learning apparatus for a pedestrian image with the edge strength EWN−1 (when slightly foggy); and

### C_{NEW} (p) is the weak learning apparatus for a pedestrian image with the edge strength EWN (when snowing).

The identification formula for a four-wheel vehicle is:

φ_{kEV4}=C_{1EV4}(p)+C_{2EV4}(p)+ . . . +C_{N-1EV4}(p)+C_{NEV4}(p); wherein

### C_{1EV4} (p) is the weak learning apparatus for a four-wheel vehicle with the edge strength EV41 (when sunny);

### C_{2EV4} (p) is the weak learning apparatus for a four-wheel vehicle with the edge strength EV42 (when raining);

### C_{N-1EV4} (p) is the weak learning apparatus for a four-wheel vehicle with the edge strength EV4N−1 (when slightly foggy); and

### C_{NEV4} (p) is the weak learning apparatus for a four-wheel vehicle with the edge strength EV4N (when snowing).

The identification formula for a two-wheel vehicle is:

φ_{kEV2}=C_{1EV2}(p)+C_{2EV2}(p)+ . . . +C_{N-1EV2}(p)+C_{NEV2}(p); wherein

### C_{1EV2} (p) is the weak learning apparatus for a two-wheel vehicle with the edge strength EV21 (when sunny);

### C_{2EV2} (p) is the weak learning apparatus for a two-wheel vehicle with the edge strength EV22 (when raining);

### C_{N-1EV2} (p) is the weak learning apparatus for a two-wheel vehicle with the edge strength EV2N−1 (when slightly foggy); and

### C_{NEV2} (p) is the weak learning apparatus for a two-wheel vehicle with the edge strength EV2N (when snowing).

Then, assuming that the edge strength in candidate area p is EV22, by example, identification formula φ_{kEV2} is selected for candidate area p, where the identification formula φ_{kEV2} is expressed as:

φ_{kEV2}=C_{1EV2}(p)+C_{2EV2}(p)+ . . . +C_{N-1EV2}(p)+C_{NEV2}(p)=0+1+ . . . +0+0≧μₖ; and

a decision is made that a two-wheel vehicle in the rain is present in candidate area p.

In another embodiment of the invention the image processor determines whether a target is projected inside of the candidate area using identification formulas when spatial frequency is used as the feature value. Spatial frequency is an index representing changes across images, and it indicates the number of waves per unit distance. For example, assume that 3 vertical lines are present in an area expressed by a rectangle with the diagonal line (x₁, y₁), (x₂, y₂). This spatial frequency can be expressed as 3/(x₂−x₁) because 3 lines are observed as waves in the lateral direction. In actuality, because a variety of textures are present within an image, which cannot be expressed using a simple wave of this kind, a wave analogy is applied to the image area so as to carry out spectral analysis in order to output the spatial frequency. In this embodiment the identification formulas are defined as follows, for example.

The identification formula for a pedestrian is:

φ_{kH}=C_{1H}(p)+C_{2H}(p)+ . . . +C_{N-1H}(p)+C_{NH}(p); wherein

### C_{1H} (p) is the weak learning apparatus for an image with the spatial frequency H1 (child);

### C_{2H} (p) is the weak learning apparatus for an image with the spatial frequency H2 (adult);

### C_{N-1H} (p) is the weak learning apparatus for an image with the spatial frequency HN−1 (person carrying large luggage); and

### C_{NH} (p) is the weak learning apparatus for an image with the spatial frequency of HN (adult with an open umbrella).

The identification formula for a dog is:

φ_{kD}=C_{1D}(p)+C_{2D}(p)+ . . . +C_{N-1D}(p)+C_{ND}(p); wherein

### C_{1D} (p) is the weak learning apparatus for an image with the spatial frequency D1 (Shiba dog);

### C_{2D} (p) is the weak learning apparatus for an image with the spatial frequency D2 (retriever);

### C_{N-1D} (p) is the weak learning apparatus for an image with the spatial frequency DN−1 (chihuahua); and

### C_{ND} (p) is the weak learning apparatus for an image with the spatial frequency DN (bulldog).

The identification formula for a still vehicle is:

φ_{kV}=C_{1V}(p)+C_{2V}(p)+ . . . +C_{N-1V}(p)+C_{NV}(p); wherein

### C_{1V} (p) is the weak learning apparatus for an image with the spatial frequency V1 (sedan);

### C_{2V} (p) is the weak learning apparatus for an image with the spatial frequency V2 (minivan);

### C_{N-1V} (p) is the weak learning apparatus for an image with the spatial frequency VN−1 (truck); and

### C_{NV} (p) is the weak learning apparatus for an image with the spatial frequency VN (two-wheel vehicle).

Then, assuming that the spatial frequency in candidate area p is DN−1, by example, identification formula φ_{kD} is selected for candidate area p, wherein the identification formula φ_{kD} is expressed as:

φ_{kD}=C_{1D}(p)+C_{2D}(p)+ . . . +C_{N-1D}(p)+C_{ND}(p)=0+0+ . . . +1+0≧μₖ; and

a decision is made that a chihuahua is present in candidate area p.

In another embodiment of the invention the image processor determines whether a target is projected inside of the candidate area using identification formulas when contrast is used as the feature value. Contrast indicates the brightness differences across areas within an image. Whereas the edge strength is used to show the difference at the boundary, this point differentiates contrast from the edge strength because mainly brightness differences within a texture are indicated in this case using contrast. When the brightness value representing area r₁ is b₁ and the brightness value representing area r₂ is b₂, the contrast is expressed as b₂−b₁. In this embodiment the identification formulas are defined as follows, for example.

The identification formula for a pedestrian is:

φ_{kCW}=C_{1CW}(p)+C_{2CW}(p)+ . . . +C_{N-1CW}(p)+C_{NCW}(p); wherein

### C_{1CW} (p) is the weak learning apparatus for a pedestrian image with the contrast CW1 (when sunny);

### C_{2CW} (p) is the weak learning apparatus for a pedestrian image with the contrast CW2 (when raining);

### C_{N-1CW} (p) is the weak learning apparatus for a pedestrian image with the contrast CWN−1 (when slightly foggy); and

### C_{NCW} (p) is the weak learning apparatus for a pedestrian image with the contrast CWN (when snowing).

The identification formula for a four-wheel vehicle is:

φ_{kCV4}=C_{1CV4}(p)+C_{2CV4}(p)+ . . . +C_{N-1CV4}(p)+C_{NCV4}(p); wherein

### C_{1CV4} (p) is the weak learning apparatus for a four-wheel vehicle with the contrast CV41 (when sunny);

### C_{2CV4} (p) is the weak learning apparatus for a four-wheel vehicle with the contrast CV42 (when raining);

### C_{N-1CV4} (p) is the weak learning apparatus for a four-wheel vehicle with the contrast CV4N−1 (when slightly foggy); and

### C_{NCV4} (p) is the weak learning apparatus for a four-wheel vehicle with the contrast CV4N (when snowing).

The identification formula for a two-wheel vehicle is:

φ_{kCV2}=C_{1CV2}(p)+C_{2CV2}(p)+ . . . +C_{N-1CV2}(p)+C_{NCV2}(p); wherein

### C_{1CV2} (p) is the weak learning apparatus for a two-wheel vehicle with the contrast CV21 (when sunny);

### C_{2CV2} (p) is the weak learning apparatus for a two-wheel vehicle with the contrast CV22 (when raining);

### C_{N-1CV2} (p) is the weak learning apparatus for a two-wheel vehicle with the contrast CV2N−1 (when slightly foggy); and

### C_{NCV2} (p) is the weak learning apparatus for a two-wheel vehicle with the contrast CV2N (when snowing).

Then, assuming that the edge strength in candidate area p is CW1, by example, identification formula φ_{kCW} is selected for candidate area p, where the identification formula φ_{kCW} is expressed as:

φ_{kCW}=C_{1CW}(p)+C_{2CW}(p)+ . . . +C_{N-1CW}(p)+C_{NCW}(p)=1+0+ . . . +0+0≧μₖ; and

a decision is made that a pedestrian under a clear sky is present in candidate area p.

In another embodiment of the invention the image processor determines whether a target is projected inside of the candidate area using identification formulas when aspect ratio is used as the feature value. Aspect ratio indicates the horizontal-to-vertical ratio of a rectangular area within an image. For example, the aspect ratio of a rectangular area within the diagonal line (x₁, y₁), (x₂, y₂) is expressed as x₂−x₁:y₂−y₁. In this embodiment the identification formulas are defined as follows, for example.

The identification formula for a pedestrian is:

φ_{kAW}=C_{1AW}(p)+C_{2AW}(p)+ . . . +C_{N-1AW}(p)+C_{NAW}(p); wherein

### C_{1AW} (p) is the weak learning apparatus for a pedestrian image in which the quadrangle that surrounds the target has the aspect ratio AW1 (child 1);

### C_{2AW} (p) is the weak learning apparatus for a pedestrian image in which the quadrangle that surrounds the target has the aspect ratio AW2 (child 2);

### C_{N-1AW} (p) is the weak learning apparatus for a pedestrian image in which the quadrangle that surrounds the target has the aspect ratio AWN−1 (adult N−1); and

### C_{NAW} (p) is the weak learning apparatus for a pedestrian image in which the quadrangle that surrounds the target has the aspect ratio AWN (adult N).

The identification formula for a four-wheel vehicle is:

φ_{kAV4}=C_{1AV4}(p)+C_{2AV4}(p)+ . . . +C_{N-1AV4}(p)+C_{NAV4}(p); wherein

### C_{1AV4} (p) is the weak learning apparatus for a four-wheel vehicle in which the quadrangle that surrounds the target has the aspect ratio AV41 (sedan);

### C_{2AV4} (p) is the weak learning apparatus for a four-wheel vehicle in which the quadrangle that surrounds the target has the aspect ratio AV42 (minivan);

### C_{N-1AV4} (p) is the weak learning apparatus for a four-wheel vehicle in which the quadrangle that surrounds the target has the aspect ratio AV4N−1 (truck); and

### C_{NAV4} (p) is the weak learning apparatus for a four-wheel vehicle in which the quadrangle that surrounds the target has the aspect ratio AV4N (bus).

The identification formula for a two-wheel vehicle is:

φ_{kAV4}=C_{1AV2}(p)+C_{2AV2}(p)+ . . . +C_{N-1AV2}(p)+C_{NAV2}(p); wherein

### C_{1AV2} (p) is the weak learning apparatus for a two-wheel vehicle in which the quadrangle that surrounds the target has the aspect ratio AV21 (bicycle 1);

### C_{2AV2} (p) is the weak learning apparatus for a two-wheel vehicle in which the quadrangle that surrounds the target has the aspect ratio AV22 (bicycle 2);

### C_{N-1AV2} (p) is the weak learning apparatus for a four-wheel vehicle in which the quadrangle that surrounds the target has the aspect ratio AV2N−1 (bike N−1); and

### C_{NAV2} (p) is the weak learning apparatus for a four-wheel vehicle in which the quadrangle that surrounds the target has the aspect ratio AV2N (bike N).

Then, assuming that the aspect ratio in candidate area p is AV4N, by example, identification formula φ_{kAV4} is selected for candidate area p, where the identification formula φ_{kAV4} is expressed as:

φ_{kAV4}=C_{1AV4}(p)+C_{2AV4}(p)+ . . . +C_{N-1AV4}(p)+C_{NAV4}(p)=0+0+ . . . +0+1≧μₖ; and

a decision is made that a bus is present in candidate area p.

Accordingly, the above-described embodiments have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. An image processor, comprising:
an image input device for capturing a pickup image; and
a controller operable to:
select a target image corresponding to the pickup image by comparing the pickup image with a plurality of prepared target images; and
identify a type of the pickup image based on the target image selected.

2. The image processor according to claim 1, wherein the controller is further operable to prepare the plurality of prepared target images.

3. The image processor according to claim 1, wherein the controller is further operable to store the plurality of prepared target images.

4. An image processor, comprising:
an image input device for capturing a pickup image; and
a controller operable to:
compute a first feature value of the pickup image;
extract second feature values of a plurality of respective prepared target images;
compare the first feature value with the second feature values;
select a second feature value corresponding to the first feature value; and
identify a type of the pickup image based on the selected second feature value.

5. The image processor according to claim 4, further comprising:
memory for storing a plurality of identification formulas associated with each of the second feature values; and wherein the controller is further operable to:
read an identification formula using the selected second feature value; and
identify the type of the pickup image based on the second feature value by identifying the type of the pickup image using the identification formula.

6. The image processor according to claim 4, wherein the first feature value or the second feature values are one or more of an optical flow, a spatial frequency, an edge strength, a contrast or an aspect ratio.

7. The image processor according to claim 4, wherein the controller is further operable to:
generate an identification formula for each of the second feature values that is able to be classified into separate types.

8. The image processor according to claim 4, further comprising:
a database for storing the prepared target images.

9. The image processor according to claim 4, wherein the controller is further operable to:
extract a target candidate area of the pickup image where the first feature value is present in the pickup image;
generate multiple identification formulas for the extracted second feature values;
select an identification formula associated with the second feature value corresponding to the first feature value; and
identify the type of the pickup image based on the selected second feature value by identifying a type of target in the target candidate area based on the identification formula.

10. The image processor according to claim 9, wherein first feature value or the second feature values are one or more of an optical flow, a spatial frequency, an edge strength, a contrast or an aspect ratio.

11. The image processor according to claim 9, wherein the controller is further operable to:
generate a respective identification formula for each of the second feature values that is able to be classified into separate types.

12. The image processor according to claim 9, further comprising:
a database for storing the plurality of respective prepared target images.

13. The image processor according to claim 4, wherein the controller is further operable to:
extract a target candidate area where the first feature value is present within the pickup image;
generate multiple identification formulas for each of the extracted second feature values; and
identify the type of the pickup image based on the selected second feature value by assigning the second feature value corresponding to the first feature value as a third feature value, selecting an identification formula that corresponds to the third feature value within the target candidate area and identifying a type of target in the target candidate area based on the identification formula.

14. An image processor, comprising:
means for capturing a pickup image;
means for selecting a target image corresponding to the pickup image by comparing the pickup image with a plurality of prepared target images; and
means for identifying a type of the pickup image based on the target image selected by the means for selecting.

15. An image processor, comprising:
an image capturing device operable to capture an image of a person in a target area; and
a controller operable to:
analyze the image of the person;
select a prepared image corresponding to the image of the person; and
identify a type of movement of the person in the target area based on the selected prepared image.

16. The image processor according to claim 15, wherein the type of movement of the person in the target area is a movement selected from the group consisting of forward movement, rearward movement, left lateral movement, right lateral movement, diagonal movement and non-movement.

17. The image processor according to claim 15, wherein the controller is further operable to:
compute a first feature value of the image of the person;
obtain a plurality of prepared images;
determine a second feature value from the plurality of prepared images;
compare the first feature value and the second feature values; and
select a prepared image having a second feature value corresponding to the first feature value.

18. The image processor according to claim 17, further comprising:
memory for storing a plurality of identification formulas associated with each of the second feature values; and wherein the controller is further operable to:
read an identification formula using the selected second feature value; and
identify the type of movement of the person in the target area based on the second feature value by identifying the type movement of the person in the target area using the identification formula.

19. The image processor according to claim 17, wherein the first feature value or the second feature values are one or more of an optical flow, a spatial frequency, an edge strength, a contrast or an aspect ratio.

20. The image processor according to claim 17, wherein the controller is further operable to:
generate an identification formula for each of the second feature values that is classifiable into a type of movement of the person in the target area.

21. The image processor according to claim 20, wherein the type of movement of the person in the target area is a movement selected from the group consisting of forward movement, rearward movement, left lateral movement, right lateral movement, diagonal movement and non-movement.

22. A method of processing an image, comprising:
computing a first feature value of a pickup image;
determining a target area where the first feature value is present within the pickup image;
extracting second feature values from prepared target image data;
generating identification formulas related to the second feature values;
selecting an identification formula associated with a second feature value corresponding to the first feature value; and
identifying a type of target in the target area based on the selected identification formula.

23. The method according to claim 22, further comprising:
selecting the first feature value from the group comprising an optical flow, a spatial frequency, an edge strength, a contrast and an aspect ratio.

24. The method according to claim 22, further comprising:
preparing the prepared target image data.

25. The method according to claim 22, further comprising:
storing the prepared target image data.

26. The method according to claim 22, further comprising:
obtaining the pickup image from an image capturing device.

27. The method according to claim 22, further comprising:
storing the identification formulas; and
wherein selecting the identification formula associated with the second feature value corresponding to the first feature value includes:
comparing the first feature value to the second feature values to identify the second feature value corresponding to the first feature value.
